(19) United States
(12) Patent Application Publication
(10) Pub. No.: US 2026/0267355 A1
(43) Pub. Date: Sep. 10, 2026

(54) CONTROL METHOD OF RIGID-FLEXIBLE INTEGRATED AERIAL CONTACT OPERATION ROBOT

(71) Applicant: Hunan University, Hunan (CN)

(72) Inventors: Hang Zhong, Hunan (CN); Jiacheng Liang, Hunan (CN); Yaonan Wang, Hunan (CN); Ling Li, Hunan (CN); Ge Chen, Hunan (CN); Caixia Zhang, Hunan (CN); Yexin Fan, Hunan (CN); Hui Zhang, Hunan (CN); Hean Hua, Hunan (CN); Weixing Peng, Hunan (CN); Yiming Jiang, Hunan (CN)

(73) Assignee: Hunan University, Hunan (CN)

(21) Appl. No.: 19/432,041

(22) Filed: Dec. 23, 2025

(30) Foreign Application Priority Data
Mar. 5, 2025 (CN) 202510251944.4

(51) Int. Cl. G05D 1/689; B25J 9/16; B25J 18/06; B64U 10/14; B64U 20/80; B64U 30/29; G05D 109/25

(52) U.S. Cl. CPC G05D 1/6895; B25J 9/1605; B25J 9/1607; B25J 9/163; B25J 9/1633; B25J 18/06; B64U 10/14; B64U 20/80; B64U 30/29; G05D 2109/254

(57) ABSTRACT

The present disclosure discloses a control method of a rigid-flexible integrated aerial contact operation robot. The robot comprises a fully-actuated unmanned aerial vehicle platform, a single-degree-of-freedom omnidirectional rotating rigid mechanism and a soft arm with single-section; the control method comprises constructing a coordinate system and establishing a forward kinematics model of the aerial contact operation robot system; constructing an inverse kinematics model of the soft arm with single-section; designing an adaptive inverse kinematics control algorithm based on reinforcement learning based on the inverse kinematics model of the soft arm with single-section; establishing a dynamic model of the fully-actuated unmanned aerial vehicle platform and designing a nonlinear model predictive control method based on an extended Kalman filter estimator, which can constrain the lateral force input of the fully-actuated unmanned aerial vehicle platform and ensure accurate tracking of the fully-actuated unmanned aerial vehicle platform under additional disturbances.

### CROSS-REFERENCE TO RELATED APPLICATION

This application claims the priority benefit of China application serial no. 202510251944.4, filed on Mar. 5, 2025. The entirety of the above-mentioned patent application is hereby incorporated by reference herein and made a part of this specification.

### BACKGROUND

### Technical Field

The present disclosure relates to the technical field of aerial operation robot control, and specifically, to a rigid-flexible integrated aerial contact operation robot and control method thereof.

### Description of Related Art

With the development of unmanned aerial vehicle and automation technologies, aerial robots equipped with robotic arms have expanded the possibilities for aerial operations, such as aerial transportation, assembly, polar scientific research, environmental sampling, as well as regular inspection and maintenance of infrastructure. However, aerial manipulation robots equipped with rigid robotic arms face challenges such as difficulties in extension and compliant motion, which limit their operational capabilities in constrained environments and significantly restrict the application of aerial active operations. In particular, the lever effect often occurs during sustained physical interaction with the environment and can have a significant impact on the aerial robot. Most existing solutions rely on compliance algorithms, with limited exploration from the fundamental principles of the aerial manipulation robot itself. However, compliance algorithms has potential safety risks in complex dynamic environments and cannot guarantee the safety of the aerial robot.

### SUMMARY

In order to overcome the technical problems in the prior art, where aerial manipulation robots equipped with rigid manipulators have difficulties in extension and compliant motion, making it challenging to perform flexible operations in constrained environments, the present disclosure provides a rigid-flexible integrated aerial contact operation robot and control method thereof.

To achieve the aforementioned technical objective, the technical solution of the present disclosure is as follows.

A rigid-flexible integrated aerial contact operation robot comprises a fully-actuated multi-rotor unmanned aerial vehicle (UAV) with tilted rotors, a rotation mechanism, and a working arm; a central portion of the rotation mechanism is fixed to a central fuselage of the multi-rotor UAV, and an outer ring portion of the rotation mechanism is rotationally assembled on the central portion and the working arm is connected to the outer ring portion so as to rotate with the outer ring portion around the central fuselage of the multi-rotor UAV. A plane formed by the working arm during its rotation with the rotation mechanism is perpendicular to a plane collectively defined by the shafts of all rotors of the multi-rotor UAV. Furthermore, during its rotation, the working arm remains clear of and does not interfere with the various rotors and their shafts.

The working arm comprises a proximal rigid arm (1) connected to the rotation mechanism, a distal rigid arm (13) equipped with an end-effector (2) at its tip, and a soft arm (3) connected between the proximal rigid arm (1) and the distal rigid arm (13). The soft arm (3) is a bending soft with a single-section structure.

The soft arm (3) of the rigid-flexible integrated aerial contact operation robot comprises two connecting disks and three soft actuators identical in shape and size connected in parallel. Both ends of the three soft actuators are fixed to the inner sides of the two connecting disks, respectively. The outer sides of the two connecting disks are connected to the ends of the proximal rigid arm (1) and the distal rigid arm (13), respectively. The three soft actuators are arranged in a triangular pattern around the center of the connecting disks; each soft actuator comprises a soft tube with a hollow cavity, a vacuum pump, and a control unit. The air pressure generated by the vacuum pump acts inside the soft tube to drive its motion, and the control unit is connected to the vacuum pump to control its activation and deactivation.

A control method of a rigid-flexible integrated aerial contact operation robot, based on the aforementioned rigid-flexible integrated aerial contact operation robot, comprises the following steps:
step 1: constructing a coordinate system group comprising a world coordinate system, a multi-rotor UAV body coordinate system, a rotation mechanism coordinate system, a soft arm base coordinate system, a soft arm end coordinate system, and an end-effector coordinate system, and based on this coordinate system group, establishing a forward kinematics model that describes the transformational relationships between the motion of the end-effector and the motions of other moving parts;
step 2: based on the end position of the soft arm, converting it into arc parameters via geometric calculation, and then further converting these into the cavity lengths of each bending soft, thereby establishing an inverse kinematics model for the soft arm;
step 3: based on the inverse kinematics model of the soft arm with single-section, using a static pressure-length hysteresis model as the hysteresis model describing the hysteretic characteristics of the soft arm to predict the hysteretic characteristics, then based on this hysteresis model, formulating a reinforcement learning-based control algorithm to achieve end-point tracking for the soft arm;
step 4: establishing a dynamic model of the fully-actuated UAV platform with six-degree-of-freedom inputs, subsequently, based on model predictive control (MPC), considering the nonlinear system dynamics and external disturbances to implement nonlinear model predictive control (NMPC) using an extended Kalman filter (EKF) estimator to constrain the states and inputs, thereby achieving lateral force constraints for the fully-actuated UAV platform with tilted rotors and completing the entire control process.

In the step 1 of the method, the forward kinematics model is expressed as:

$${T}_{E}^{I} = {T}_{B}^{I} {T}_{M}^{B} {T}_{E}^{M} = [ \begin{matrix}{R}_{E}^{I} & {p}_{e} \\ 0 & 1\end{matrix} ] ;$$

$$where {R}_{E}^{I} = {R}_{B}^{I} {R}_{M}^{B} {R}_{E}^{M} , {p}_{e} = {p}_{b} + {R}_{B}^{I} ( {p}_{m}^{b} + {R}_{M}^{B} {p}_{e}^{m} ) ; \\ {T}_{*}^{★} ∈ {ℝ}^{4 \times 4} and {R}_{*}^{★} ∈ {ℝ}^{3 \times 3}$$

represent the transformation matrix and rotation matrix from a coordinate system “*” to a coordinate system. “*” respectively, and symbol *={B,M,E} and symbol *={I,B,M}, [symbol] denotes the set of real numbers, B represents a body coordinate system [symbol] _{B} of a UAV platform, M represents the rotation mechanism coordinate system [symbol] _{M}, E represents the end-effector coordinate system [symbol] _{E} and I represents the world coordinate system [symbol] _{I}; pₑ=[xₑ,yₑ,zₑ]^{T}∈ [symbol] ³ is the position of the end-effector in the world coordinate system [symbol] _{I},

$${p}_{m}^{b} ∈ {ℝ}^{3}$$

is the joint position of the rotation mechanism in the body coordinate system [symbol] _{B},

$${p}_{e}^{m} ∈ {ℝ}^{3}$$

the end-effector in the rotation mechanism coordinate system [symbol] ₘ, the superscript T denotes matrix transpose, and p_{b} is the position of the UAV platform in the world coordinate system [symbol] _{I}.

In the method, the transformation matrix is

$${T}_{E}^{M} = {T}_{S 0}^{M} {T}_{S 1}^{S 0} {T}_{E}^{S 1} , where {T}_{S 0}^{M}$$

is the transformation matrix between the rotation mechanism coordinate system [symbol] _{M} and the soft arm base coordinate system [symbol] _{S0},

$${T}_{S 1}^{S 0}$$

represent the transformation matrix between the soft arm base coordinate system [symbol] _{S0} and the soft manipulator end coordinate system [symbol] _{S1}, and

$${T}_{E}^{S 1}$$

is the transformation matrix between the end-effector coordinate system [symbol] _{E} and the soft manipulator end coordinate system [symbol] _{S1}. Furthermore:

$$\begin{matrix}{T}_{S 0}^{S 1} = [ \begin{matrix}{R}_{z} ( ϕ ) & 0 \\ 0 & 1\end{matrix} ] [ \begin{matrix}{R}_{y} ( θ ) & {p}_{θ} \\ 0 & 1\end{matrix} ] [ \begin{matrix}{R}_{z} ( - ϕ ) & 0 \\ 0 & 1\end{matrix} ] \\ = [ \begin{matrix}{R}_{S 0}^{S 1} & {p}_{S 0}^{S 1} \\ 0 & 1\end{matrix} ]\end{matrix} ;$$

$$where , {R}_{S 0}^{S 1} = [ \begin{matrix}{c}_{ϕ}^{2} ( {c}_{θ} - 1 ) + 1 & {s}_{ϕ} {c}_{ϕ} ( {c}_{θ} - 1 ) & {c}_{ϕ} {s}_{θ} \\ {s}_{ϕ} {c}_{ϕ} ( {c}_{θ} - 1 ) & {s}_{ϕ}^{2} ( {c}_{θ} - 1 ) + 1 & {s}_{ϕ} {s}_{θ} \\ - {c}_{ϕ} {s}_{θ} & - {c}_{ϕ} {s}_{θ} & {c}_{θ}\end{matrix} ] ,$$

$${p}_{S 0}^{S 1} = {[ {x}_{e} , {y}_{e} , {z}_{e} ]}^{T} \text{?} {γ [ {c}_{ϕ} ( 1 - {c}_{θ} ) , {s}_{ϕ} ( 1 - {c}_{θ} ) , {s}_{θ} ]}^{T} , {c}_{ϕ} , {s}_{ϕ} , {c}_{θ} and {s}_{θ}$$

represent cos φ, sin φ, cos θ and sin θ respectively, where φ is the curvature angle of the soft arm, and θ is the bending angle of the soft arm;

$${p}_{S 0}^{S 1} and {R}_{S 0}^{S 1}$$

represent the translational motion and rotational motion in the soft arm base coordinate system [symbol] _{S0} respectively. R_{y}(θ) represents the rotation angle of the soft arm around the y-axis of the soft arm base coordinate system [symbol] _{S0}. R_{z}(φ) represents the rotation angle φ around the z-axis of the soft arm base coordinate system [symbol] _{S0}. xₛ, yₛ, zₛ are the x-axis, y-axis, and z-axis coordinates of the soft arm's task space, i.e., the desired end-position to be reached.
The step 2 in the above method comprises:
step 201: converting the end position {xₛ,yₛ,zₛ} into arc parameters {ρ,φ,θ} by the following calculation formula:

$$\{ \begin{matrix}ϕ = {tan}^{- 1} ( \frac{{y}_{s}}{{x}_{s}} ) \\ ρ = \frac{1}{r} = \frac{2 \sqrt{{x}_{s}^{2} + {y}_{s}^{2}}}{{x}_{s}^{2} + {y}_{s}^{2} + {z}_{s}^{2}} \\ θ = {cos}^{- 1} ( 1 - ρ \sqrt{{x}_{s}^{2} + {y}_{s}^{2}} )\end{matrix} ;$$

wherein r is the radius of curvature, and ρ is the curvature of the soft arm;
step 202, calculating the cavity length of each bending soft actuator by the following calculation formula:

$$ρ = \frac{1}{r} = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{h ( {l}_{1} + {l}_{2} + {l}_{3} )} ;$$

$$ϕ = {tan}^{- 1} ( \frac{\sqrt{3} ( {l}_{2} + {l}_{3} - 2 {l}_{1} )}{3 ( {l}_{2} - {l}_{3} )} ) ;$$

$$θ = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{3 h} ;$$

constraint conditions are:

$${l}_{i} = r θ - θ h cos [ \frac{2 π}{3} ( i - 1 ) + \frac{π}{2} - ϕ ] , i = 1 , 2 , 3 ;$$

where lᵢ represents the cavity length of the i-th bending soft, h represents the radius of the cross-section, and π represents the circular constant.

In the step 3 of the above method, the hysteresis model is expressed by the following formula:

$$\{ \begin{matrix}{u}_{p}^{( k )} = {Γ}_{CPI} ( {l}^{( k )} ) + {Γ}_{UPI} ( {l}^{( k )} ) + W ( {l}^{( k )} ) \\ {Γ}_{CPI} ( {l}^{( k )} ) = {a}_{0} {l}^{( k )} + {\sum }_{j = 1}^{{N}_{c}} {b}_{j} {G}_{{γ}_{j} , {c}_{j} , 1} ( {l}^{( k )} ) \\ {Γ}_{UPI} ( {l}^{( k )} ) = {\sum }_{j = 1}^{{N}_{u}} {δ}_{j} {G}_{{γ}_{j} , {c}_{j} , {d}_{j}} ( {l}^{( k )} ) \\ W ( {l}^{( k )} ) = {\sum }_{j = 2}^{{N}_{w}} {{W}_{j} ( {l}^{( k )} )}^{j} + {w}_{0} \\ {G}_{{γ}_{j} , {c}_{j} , {d}_{j}} ( {l}^{( k )} ) = max \{ {c}_{j} ( {l}^{( k )} - {γ}_{j} ) , min \{ {d}_{j} ( {l}^{( k )} + {γ}_{j} ) , {G}_{{γ}_{j} , {c}_{j} , {d}_{j}} ( {l}^{( k - 1 )} ) \} \}\end{matrix} ;$$

where l^{(k)} is the cavity length,

$${u}_{p}^{( k )}$$

is the pressure music the cavity in the hysteresis model, the pressure is expressed through the symmetric part Γ_{CPI}(l^{(k)}), the asymmetric part Γ_{UPI}(l^{(k)}) and the polynomial part W(l^{(k)}) to fit the formal curve; G_{γ}_{ⱼ}_{c}_{ⱼ}_{,d}_{ⱼ}(l^{(k)}) is the operator output of the hysteresis model, the superscript (k) denotes the k-th value; a₀ is the linear weight gain, while bᵢ, δᵢⱼ and wᵢ are the weight gains of the symmetric, asymmetric, and polynomial parts, respectively; γⱼ is the j-th dead zone, corresponding to the input signal range where the output is zero; cⱼ and dⱼ are the j-th inclination angles of the cavity during pressurization and depressurization, respectively; w₀ is the offset associated with the operating angle of the hysteresis curve; N_{c} and N_{w} are the numbers of symmetric and polynomial parts, respectively; Nᵤ is the total number of dead zones in the asymmetric part;
then, a proportional-integral-derivative control compensation term

$${u}_{c}^{( k )}$$

is introduced as a feedback term to modify the feedforward term

$${u}_{p}^{( k )}$$

in the hysteresis model in real time, given by:

$${u}_{a}^{( k )} = {u}_{p}^{( k )} + {u}_{c}^{( k )} ;$$

$${u}_{c}^{( k )} = {k}_{p} {\tilde{l}}^{( k )} + {k}_{i} \int {\tilde{l}}^{( k )} dt + {k}_{d} {\dot{\tilde{l}}}^{( k )} ;$$

where \tilde{l}^{(k)} denotes the cavity length error

$${\tilde{l}}^{( k )} = {l}_{d}^{( k )} - {l}^{( k )} , {l}_{d}^{( k )}$$

is the desired cavity length, l^{(k)} is the actual cavity length, and \tilde{l}^{(k)},

$${l}_{d}^{( k )} and {l}^{( k )}$$

are calculated from a desired position or an actual position of the end-point of the soft arm using formula in the step 201 to calculate the arc parameters {ρ,φ,θ}, and then using the constraint conditions for calculating the cavity length of each bending soft in the step 202; [symbol] ^{(k)} is the first derivative of \tilde{l}^{(k)}; kₚ, kᵢ and k_{d} are the proportional, integral, and derivative coefficients, respectively; wherein the proportional coefficient kₚ is configured as an exponential as function expressed as

$${k}_{p} = {k}_{p 0} + {λ}_{1} {e}^{( {λ}_{2} - \frac{{λ}_{3}}{{\vert {\tilde{l}}^{( k )} \vert}^{}} )} ;$$

where kₚ₀ is a constant term, and λ₁, λ₂ and λ₃ are terms determining the exponent value, all being positive constants, and are determined online via a reinforcement learning-based control algorithm.

In the step 3 of the above-mentioned method, setting the reinforcement learning-based control algorithm according to the hysteresis model comprises:

employing an epsilon (ϵ)-greedy policy to enable the soft arm to select optimal actions through learning, wherein the ϵ-greedy policy is defined as:

$$\{ \begin{matrix}if rand ( ) < ∈ , {A}^{( k )} ← {rand}_{A} ( 𝔸 \{ {A}_{1} , {A}_{2} , {A}_{3} , {A}_{4} \} ) \\ else if {\tilde{l}}^{( k )} ∈ {S}_{1} , {A}^{( k )} ← {max}_{A} V ( {S}_{1} , \{ {A}_{1} \} ) \\ else if {\tilde{l}}^{( k )} ∈ {S}_{2} , {A}^{( k )} ← {max}_{A} V ( {S}_{2} , \{ {A}_{1} , {A}_{2} \} ) \\ else if {\tilde{l}}^{( k )} ∈ {S}_{3} , {A}^{( k )} ← {max}_{A} V ( {S}_{3} , \{ {A}_{2} , {A}_{3} \} ) \\ else if {\tilde{l}}^{( k )} ∈ {S}_{4} , {A}^{( k )} ← {max}_{A} V ( {S}_{4} , \{ {A}_{3} , {A}_{4} \} ) \\ else if {\tilde{l}}^{( k )} ∈ {S}_{5} , {A}^{( k )} ← {max}_{A} V ( {S}_{5} , \{ {A}_{2} , {A}_{3} \} ) \\ else if {\tilde{l}}^{( k )} ∈ {S}_{6} , {A}^{( k )} ← {max}_{A} V ( {S}_{6} , \{ {A}_{1} , {A}_{2} \} ) \\ else if {\tilde{l}}^{( k )} ∈ {S}_{7} , {A}^{( k )} ← {max}_{A} V ( {S}_{7} , \{ {A}_{1} \} )\end{matrix} ;$$

where rand( ) represents an initial random assignment for decision-making, parameter ϵ∈(0, 1), V( [symbol] , [symbol] )∈ [symbol] ^{7×4} is a state-action value function, expressed as:

$$V ( {S}_{i}^{( k )} , {A}_{i}^{( k )} ) ← \text{} V ( {S}_{i}^{( k )} , {A}_{i}^{( k )} ) + β [ R ( {S}_{i}^{( k + 1 )} , {A}_{i}^{( k + 1 )} ) + σ V ( {S}_{i}^{( k + 1 )} , {A}_{i}^{( k + 1 )} ) - V ( {S}_{i}^{( k )} , {A}_{i}^{( k )} ) ] ;$$

where β is the learning rate, σ is the discount factor; [symbol] is the state space, which comprises seven continuous and symmetric intervals S₁-S₇:

$$S = \{ {S}_{1} , {S}_{2} , {S}_{3} , {S}_{4} , {S}_{5} , {S}_{6} , {S}_{7} \}$$

$$\{ \begin{matrix}{S}_{1} \text{:} \tilde{l} ∈ ( - ∞ , - 50 ) ; & {S}_{2} \text{:} \tilde{l} ∈ [ - 50 , - 1 ) ; \\ {S}_{3} \text{:} \tilde{l} ∈ [ - 1 , - 0.0001 ) ; & {S}_{4} \text{:} \tilde{l} ∈ [ - 0.0001 , 0.0001 ] ; \\ {S}_{5} \text{:} \tilde{l} ∈ ( 0.0001 , 1 ] , & {S}_{6} \text{:} \tilde{l} ∈ ( 1 , 50 ] \\ {S}_{1} \text{:} \tilde{l} ∈ ( 5 , + ∞ ) & \end{matrix}$$

[symbol] is the action space comprising four actions A₁-A₄, and:

$$𝔸 = \{ {A}_{1} , {A}_{2} , {A}_{3} , {A}_{4} \} ,$$

$${A}_{i} \text{:} [ {k}_{p 0} , {λ}_{1} , {λ}_{2} , {λ}_{3} \} , i = 1 , … , 4.$$

In the step 4 of the above-mentioned method, the dynamic model of the fully-actuated UAV platform with six-degree-of-freedom inputs is expressed as:

$$[ \begin{matrix}{m}_{g} {\dot{v}}_{b} \\ {J}_{b} {\dot{ω}}_{b}\end{matrix} ] + [ \begin{matrix}{{m}_{g} [ 00 g ]}^{T} \\ {ω}_{b} \times {J}_{b} {ω}_{b}\end{matrix} ] = [ \begin{matrix}{F}_{c} \\ {τ}_{c}\end{matrix} ] + [ \begin{matrix}{F}_{e} \\ {τ}_{e}\end{matrix} ] ;$$

where mₛ is the total mass of the fully-actuated UAV platform, J_{b} is the inertia matrix of the fully-actuated UAV platform, and g is the gravitational constant; the vector \dot{v}_{b} is the first derivative of the vector v_{b}, where v_{b} is the linear velocity of the fully-actuated UAV platform in the world coordinate system; ω_{b} is the angular velocity of the fully-actuated UAV platform in the body coordinate system, and the vector \dot{ω}_{b} is the first derivative of ω_{b}; F_{c} and τ_{c} are the control input force and moment of the fully-actuated UAV platform, respectively; Fₑ and τₑ are the disturbance force and moment force acting on the fully-actuated UAV platform, respectively;
the position and attitude dynamics of the fully-actuated UAV platform are expressed as:

$${\dot{p}}_{b} = {v}_{b} ;$$

$${\dot{p}}_{b} = \frac{1}{2} {q}_{b} ⊗ [ \begin{matrix}0 \\ {ω}_{b}\end{matrix} ] ;$$

where the vector \dot{p}_{b} is the first derivative of the vector p_{b}, with p_{b} being the position of the fully-actuated UAV platform in the world coordinate system; the vector \dot{q}_{b} is the first derivative of the vector q_{b}, with q_{b} being the attitude of the fully-actuated UAV platform represented by a quaternion.

In the step 4 of the above-mentioned method, implementing lateral force constraints for the fully-actuated UAV platform comprises:
representing the state vector x and the input vector u as:

$$x = {[ {p}_{b}^{T} , {v}_{b}^{T} , {q}_{b}^{T} , {ω}_{b}^{T} ]}^{T} ;$$

$$u = {[ {F}_{e}^{T} , {τ}_{e}^{T} ]}^{T} ;$$

the system dynamics are described by the dynamic model of the fully-actuated UAV platform along with the expressions for the position and attitude dynamics position and attitude dynamics, and the nonlinear optimal control is formulated as:

$${min}_{{v}_{i}} {\sum }_{k = 0}^{N - 1} ( {x}_{k}^{T} {Q}_{x} {x}_{k} + {u}_{k}^{T} {R}_{u} {u}_{k} ) + {x}_{N}^{T} {Q}_{N} {x}_{N}$$

$$subject to :$$

$${x}_{0} = x , \dot{x} = f ( x ) ,$$

$${x}_{k} ∈ 𝕏 , {u}_{k} ∈ 𝕌 ,$$

$${F}_{e} = {\hat{F}}_{e} , {τ}_{e} = {\hat{τ}}_{e} ,$$

where \tilde{x}ₖ=xₖ−x_{k,d}, ũₖ=uₖ−u_{k,d}, with x_{k,d} and u_{k,d} being the desired state vector and desired input vector, respectively; Qₓ≥0 and Rᵤ≥0 denote the penalty matrices for a state and an input, respectively, and Q_{N} represents the penalty matrix for a terminal state; N indicates a prediction step size; [symbol] and [symbol] are the state and input constraints, respectively; \hat{F}ₑ and \hat{τ}ₑ are the estimated disturbance force and the estimated moment, respectively;
furthermore, the state vector \hat{x}_{EKF} and input vector u_{ERF} of the extended Kalman filter estimator are defined as:

$${\hat{x}}_{EKF} = {[ {\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T} ]}^{T} ,$$

$${u}_{EKF} = {[ {F}_{e}^{T} , {τ}_{e}^{T} ]}^{T} ;$$

$$where$$

$${\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T}$$

represent the estimated values of the variables

$${p}_{b}^{T} , {v}_{b}^{T} , {q}_{b}^{T} , {ω}_{b}^{T} , {F}_{e}^{T} , {τ}_{e}^{T}$$

based on the extended Kalman filter; the measured position, attitude, linear velocity, and angular velocity of the fully-actuated UAV platform are used as the measurement vector z_{EKF} of the extended Kalman filter, i.e.:

$${z}_{EKF} = {[ {p}_{b}^{T} , {v}_{b}^{T} , {q}_{b}^{T} , {ω}_{b}^{T} ]}^{T} ;$$

then, the system dynamics and constraints are discretized on discrete-time sequences t₀, . . . , t_{N} of sampling intervals, where a 4^{th}-order implicit Runge-Kutta integrator is used to forward simulate the system dynamics along the intervals, and then the boundary value is solved for each sampling interval to obtain the estimated force \hat{F}ₑ and estimated moment \hat{τ}ₑ, thereby solving the expression of the nonlinear optimal control.

The technical effect of the present disclosure is that the soft arm of the present disclosure is mounted on a UAV platform and performs functions similar to those of traditional rigid-link robotic arms. As the trade-off between arm weight and degrees of freedom in traditional rigid-link robotic arms limits their flexibility and operability, the inherent compliance of soft arms ensures safe operation and robust interaction with the environment. Therefore, by leveraging the agility and flexibility of UAVs and integrating soft arms, the required compliance and inherent safety can be enhanced, enabling flexible aerial operations in constrained environments. The present disclosure addresses the strong lever effect exerted on the UAV platform by traditional integrated rigid manipulators in aerial contact-based robotic systems during sustained aerial interactive manipulation. It effectively mitigates the impact on the stability of fully actuated UAV platforms during sustained aerial manipulation and enables flexible manipulation tasks in constrained environments using soft arms.

### BRIEF DESCRIPTION OF THE DRAWINGS

FIG. 1 is a structural schematic diagram of an aerial contact-operating robot according to an embodiment of the present disclosure.

FIG. 2 is a flowchart of manufacturing a soft arm for the aerial contact-operating robot according to an embodiment of the present disclosure.

FIG. 3 is an overall flowchart of the method according to an embodiment of the present disclosure.

FIG. 4 is a flowchart of the computational process of the method according to an embodiment of the present disclosure.

### DESCRIPTION OF THE EMBODIMENTS

For a better understanding of the technical solutions of the present disclosure by those skilled in the art, the following further describes the present disclosure with reference to the embodiments and accompanying drawings.

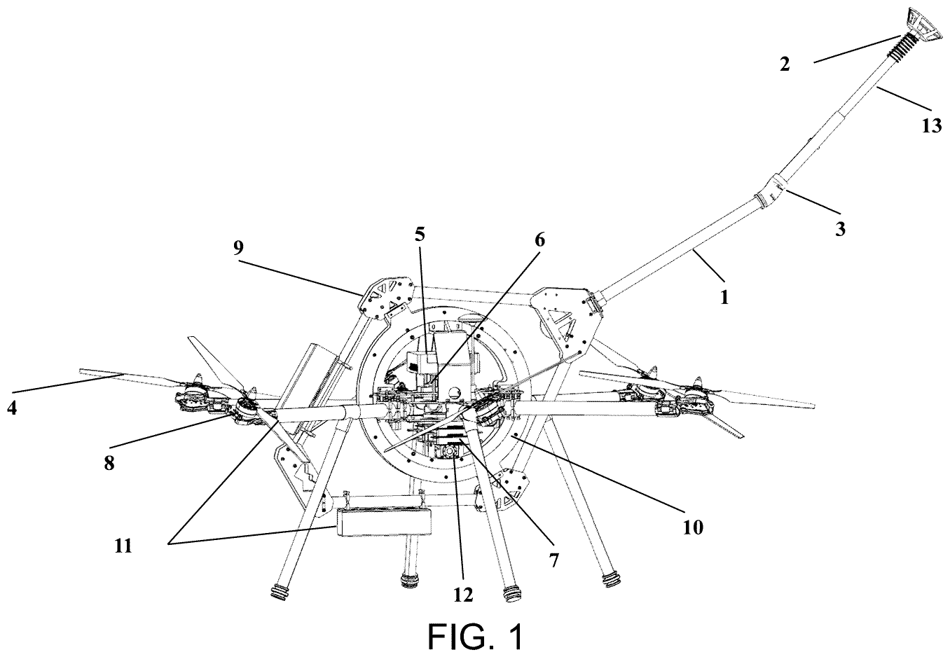

Referring to FIG. 1, the fully actuated UAV platform provided in this embodiment is developed from a traditional hexacopter. In this embodiment, the propellers 4 of the UAV platform are tilted at a fixed angle of 30° and point in different directions. This configuration enables independent control of the position and attitude of the UAV platform. Specifically, while the UAV possesses motion capability in six degrees of freedom, traditional underactuated UAVs have only four control inputs, requiring indirect control of positional movement in the x and y directions through roll and pitch angles. In contrast, the fully actuated system has six control inputs, allowing independent control of all six degrees of freedom in position and attitude. An onboard computer 5 is mounted on the base of the fully actuated UAV platform in this embodiment to process high-level control signals, along with a flight controller 6 for processing low-level flight signals. The rotor speed commands generated by the flight controller 6 are transmitted to the electronic speed controllers 7 to drive the motors 8 and propellers 4.

The UAV in this embodiment is equipped with a single-degree-of-freedom rotating mechanism, which is a rigid mechanism 9 capable of 360° omnidirectional rotation. It comprises a main frame, a transmission mechanism 10, a working arm, a power module 11, and a driving servo 12. The main frame serves as the outer structure and is rigidly connected to the UAV platform via a central transmission mechanism 10 composed of gears. One end of the main frame of the rotating mechanism is equipped with a proximal rigid arm 1 that serves as an intermediate connection. The opposite end is designed with two battery mounting plates, which hold the two batteries of the power module 11 that powers the entire operating robot. These batteries act as counterweights to balance the torque generated by the weight of the working arm, including the end-effector 2, ensuring that the center of gravity of the rotating mechanism remains at the body's center, thereby mitigating center-of-gravity shift issues caused by the rotating mechanism.

The main frame and the flight platform are connected via the transmission mechanism, enabling the working arm and the end-effector 2 to perform 360° omnidirectional rotational operations. The plane formed by the rotation of the working arm is perpendicular to the plane defined by the axes of the multi-rotor UAV's propellers, while the working arm avoids interference with the propellers and their axes during rotation. A rotating mechanism connector simultaneously links the main frame and the large transmission gear of the transmission mechanism. The large transmission gear incorporates a 360° gear sliding slot, which meshes with the small transmission gear on the driving servo 12, allowing the operating mechanism to rotate to any angle. A servo connector simultaneously connects the driving servo 12 and the flight platform for rigid fixation.

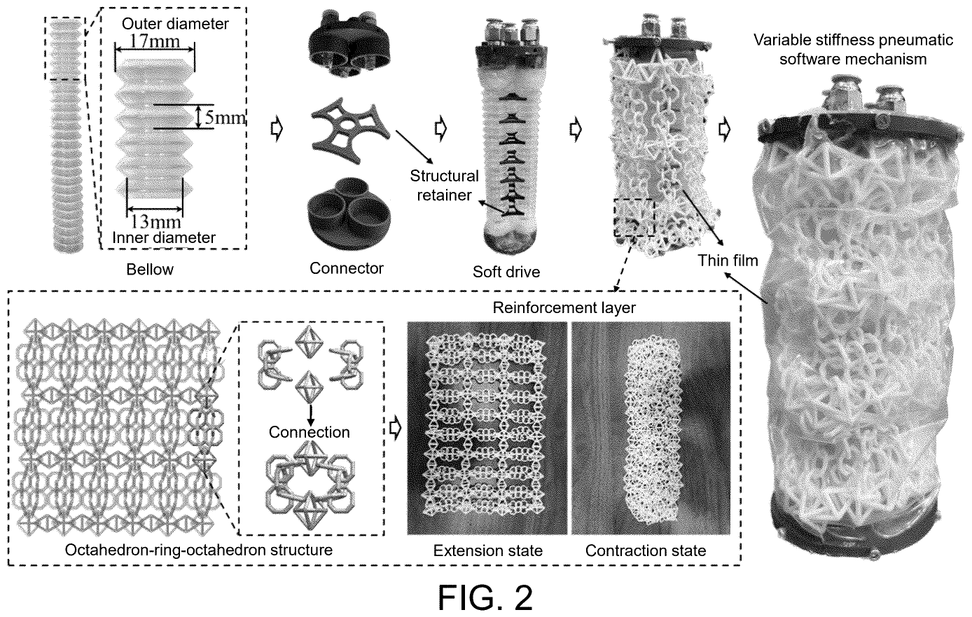

Referring to FIG. 2, the soft arm 3 in this embodiment is installed between the proximal rigid arm 1 and the distal rigid arm 13 of the working arm. The soft arm 3 comprises two connecting disks and three soft actuators with identical shape and size connected in parallel. Both the proximal rigid arm 1 and the distal rigid arm 13 are connected to the soft arm 3 via the connecting disks. Both ends of the three soft actuators are fixed to the inner sides of the two connecting disks, while the outer sides of the two connecting disks are connected to the ends of the proximal rigid arm 1 and the distal rigid arm 13, respectively. The three soft actuators are arranged in a triangular pattern around the center of the connecting disks. In this embodiment, three bellows of the same size are selected as the soft actuators, and each bellow is evacuated to contract. To ensure the axes of the soft actuators remain relatively parallel during contraction, multiple Y-shaped structural retainers are installed in parallel between the three bellows for support and limitation. The soft actuators are also equipped with a vacuum pump and a control unit. The vacuum pump generates air pressure acting inside the soft tubes to drive their motion, and the control unit is connected to the vacuum pump to control its activation and deactivation. The control unit in this embodiment includes a micro relay for switching the cavity pressure and a microcontroller for signal processing.

In this embodiment, an octahedron-ring-octahedron connection structure is employed on the exterior of the bellows to form a reinforcement layer for enhanced structural strength. This octahedron-ring-octahedron configuration offers greater flexibility compared to an octahedron-octahedron connection structure. Specifically, each octahedron is a hollow frame structure. At the base, two chains, each composed of multiple interconnected rings, connect one octahedron to another, forming an octahedron-ring-octahedron connection unit. Multiple identical units are interconnected, while two parallel octahedrons are linked via an additional octahedron, collectively constituting the reinforcement layer. Finally, the exterior of the reinforcement layer is sealed with a soft membrane, resulting in a lightweight reinforced soft arm with single-section. While this embodiment utilizes a pneumatic soft tube structure as the soft arm, alternative soft driving mechanisms such as concentric tubes, cable-driven systems, and magnetic drives may also be considered in practical applications.

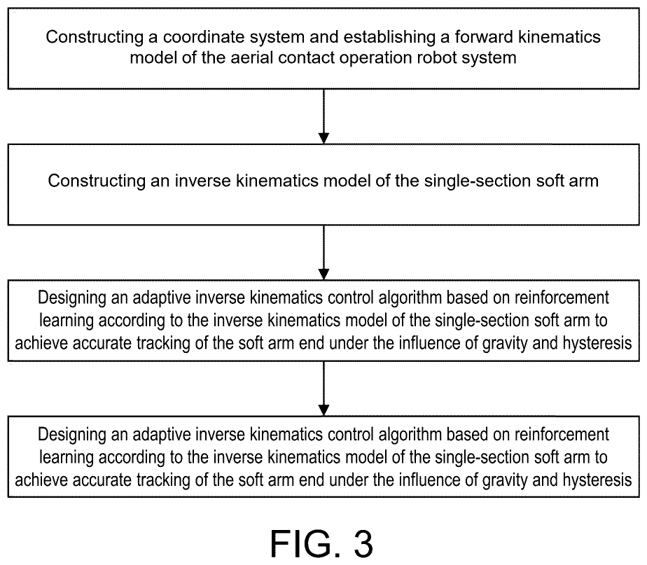

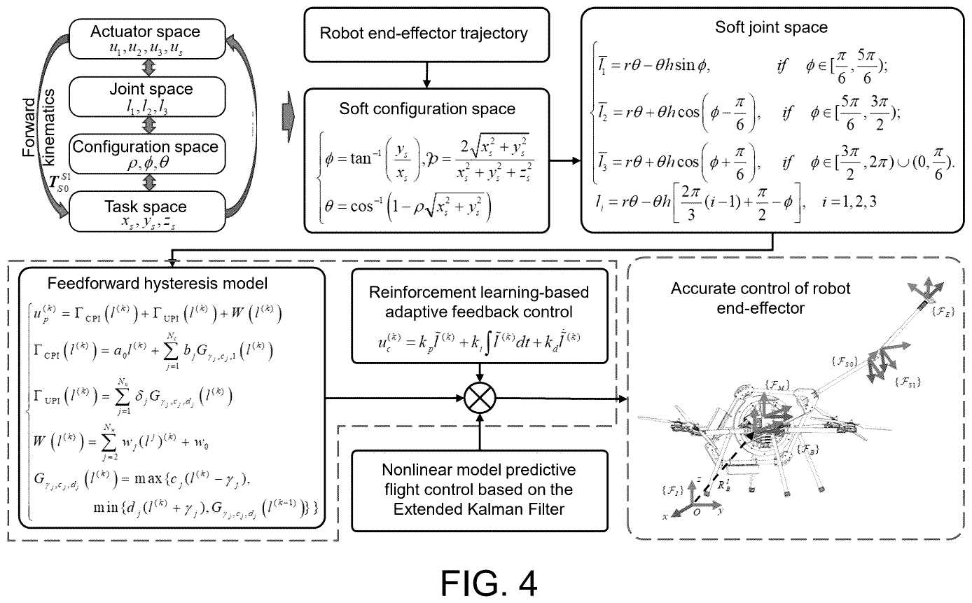

Referring to FIGS. 3 and 4, this embodiment also provides a rigid-flexible integrated aerial contact operation robot and control method, used to control the aforementioned aerial contact-operating robot with rigid-flexible integration. The method comprises the following steps:
step 1: constructing a coordinate system group including a world coordinate system, a multi-rotor UAV body coordinate system, a rotating mechanism coordinate system, a soft arm base coordinate system, a soft arm end coordinate system, and an end-effector coordinate system; based on the coordinate system group, establishing a forward kinematics model describing the transformation relationships between the motion of the end-effector and the motions of other moving parts, where position and linear velocity signals are measured and acquired by external sensors, while attitude and angular velocity signals are obtained from the onboard inertial measurement unit (IMU).

Specifically, the step 1 begins by defining six coordinate systems to describe the kinematics of the rigid-integrated aerial contact-operating robot system: the world coordinate system [symbol] _{I}, body coordinate system [symbol] _{B} of the UAV platform, the rotating mechanism coordinate system [symbol] _{M}, the soft arm base coordinate system [symbol] _{S0}, the soft manipulator end coordinate system [symbol] _{S1}, and the end-effector coordinate system [symbol] _{E}. After establishing the robot system coordinate systems, the forward kinematics are derived to resolve the transformation between the end-effector motion and the vehicle/joint displacements. The forward kinematics are described as follows:

$${T}_{E}^{I} = {T}_{B}^{I} {T}_{M}^{B} {T}_{E}^{M} = [ \begin{matrix}{R}_{E}^{I} & {p}_{e} \\ 0 & 1\end{matrix} ] ; \qquad ( 1 )$$

$$where ,$$

$${R}_{E}^{I} = {R}_{B}^{I} {R}_{M}^{B} {R}_{E}^{M} ,$$

$${p}_{e} = {p}_{b} + {R}_{B}^{I} ( {p}_{m}^{b} + {R}_{M}^{B} {p}_{e}^{m} ) ;$$

$${T}_{*}^{⋆} ∈ {ℝ}^{4 \times 4} and {R}_{*}^{⋆} ∈ {ℝ}^{3 \times 3}$$

denote the transformation matrix and rotation matrix from a coordinate system “*” to a coordinate system “*”, respectively; the symbol *={B,M,E} and the symbols *={I,B,M}, [symbol] represent the set of real numbers; B denotes the body coordinate system [symbol] _{B} of the UAV platform, M represents the rotation mechanism coordinate system [symbol] _{M}, E represents the end-effector coordinate system [symbol] _{E}, and/represents the world coordinate system [symbol] _{I}; pₑ=[xₑ,yₑ,zₑ]^{T}∈ [symbol] ³ is the position of the end-effector in the world coordinate system [symbol] _{I},

$${p}_{m}^{b} ∈ {ℝ}^{3}$$

is the position or the rotating mechanism in the body coordinate system [symbol] _{B}, and

$${p}_{e}^{m} ∈ {ℝ}^{3}$$

is the position of the end-effector in the rotating mechanism coordinate system [symbol] _{M}; the superscript T denotes matrix transpose, and p_{b} denotes the position of the UAV platform in the world coordinate system [symbol] _{I}.

It should be noted that the matrix

$${T}_{E}^{M} = {T}_{S 0}^{M} {T}_{S 1}^{S 0} {T}_{E}^{S 1}$$

encompasses the transformation between the base and the end of the soft arm

$${T}_{S 1}^{S 0} \cdot {T}_{S 0}^{M}$$

denotes the transformation matrix between the rotating mechanism coordinate system [symbol] _{M} and the soft arm base coordinate system [symbol] _{S0}, while

$${T}_{E}^{S 1}$$

denotes the transformation matrix between the end-effector coordinate system [symbol] _{E} and the soft manipulator end coordinate system [symbol] _{S1}. Since the three cavities of the soft arm are assembled in a parallel structure, the soft arm is considered to possess a constant curvature. To derive the forward kinematics of the soft arm, it is necessary to determine the mapping from the actuator space {u₁,u₂,u₃,uₛ} to the soft arm task space {xₛ,yₛ,zₛ}, where the reinforcement layer pressure Us is isolated from the cavity pressures {u₁,u₂,u₃} and is solely used to activate the reinforcement layer. The transformation from the soft arm joint space {l₁,l₂,l₃} to the soft arm configuration space {ρ,φ,θ} is expressed as:

$$ρ = \frac{1}{r} = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{h ( {l}_{1} + {l}_{2} + {l}_{3} )} ; \qquad ( 2 )$$

$$ϕ = {tan}^{- 1} ( \frac{\sqrt{3} ( {l}_{2} + {l}_{3} - 2 {l}_{1} )}{3 ( {l}_{2} - {l}_{3} )} ) ; \qquad ( 3 )$$

$$θ = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{3 h} ; \qquad ( 4 )$$

where, lᵢ represents the cavity length of the i-th bending soft; ρ, φ and θ denote the curvature, curvature angle, and bending angle of the soft arm, respectively; h represents the radius of the cross-section; u₁, u₂ and u₃ represent the air pressures of the first, second, and third cavities, respectively; xₛ, yₛ and zₛ represent the position of the soft arm end in the x-y-z directions, respectively. To model the transformation

$${T}_{S 0}^{S 1}$$

from the configuration space {ρ,φ,θ} to the task space {xₛ,yₛ,zₛ}, first, the soft arm base coordinate system [symbol] _{S0} is rotated by an angle θ around the y-axis of the base frame, i.e. R_{y}(θ); subsequently, the soft arm base coordinate system [symbol] _{S0} is rotated by an angle φ around the z-axis of the base frame, i.e. R_{z}(φ); then, the soft arm is translated out of the x-z plane by p₀=r[1−c₀,0,s₀]^{T}, where r=1/ρ is the radius of curvature; finally, the orientation is adjusted by right-multiplying the rotation matrix R(−φ). Therefore, the transformation matrix is expressed as follows:

$$\begin{matrix}{T}_{s 0}^{S 1} = [ \begin{matrix}{R}_{z} ( ϕ ) & 0 \\ 0 & 1\end{matrix} ] [ \begin{matrix}{R}_{y} ( θ ) & {p}_{θ} \\ 0 & 1\end{matrix} ] [ \begin{matrix}{R}_{z} ( - ϕ ) & 0 \\ 0 & 1\end{matrix} ] \\ = [ \begin{matrix}{R}_{S 0}^{S 1} & {p}_{S 0}^{S 1} \\ 0 & 1\end{matrix} ]\end{matrix} ; \qquad ( 5 )$$

$${R}_{S 0}^{S 1} = [ \begin{matrix}{c}_{ϕ}^{2} ( {c}_{θ} - 1 ) + 1 & {s}_{ϕ} {c}_{ϕ} ( {c}_{θ} - 1 ) & {c}_{ϕ} {s}_{θ} \\ {s}_{ϕ} {c}_{ϕ} ( {c}_{θ} - 1 ) & {s}_{ϕ}^{2} ( {c}_{θ} - 1 ) + 1 & {s}_{ϕ} {s}_{θ} \\ - {c}_{ϕ} {s}_{θ} & - {c}_{ϕ} {s}_{θ} & {c}_{θ}\end{matrix} ] ; \qquad ( 6 )$$

$${p}_{S 0}^{S 1} = {[ {x}_{e} , {y}_{e} , {z}_{e} ]}^{T} \text{?} {γ [ {c}_{ϕ} ( 1 - {c}_{θ} ) , {s}_{ϕ} ( 1 - {c}_{θ} ) , {s}_{θ} ]}^{T} ; \qquad ( 7 )$$

where, c_{φ}, s_{φ}, c_{θ} and s_{θ} are represented as cos φ, sin φ, cos θ and sin θ respectively;

$${p}_{S 0}^{S 1} and {R}_{S 0}^{S 1}$$

denote the translational and rotational motions in the soft arm base coordinate system [symbol] _{S0}, respectively.
Step 2, based on the end position of the soft arm, it is converted into arc parameters through geometric calculation, which are then further transformed into the cavity lengths of each bending soft actuator, thereby establishing the inverse kinematics model of the soft arm.

Specifically, to determine the end motion of the soft arm, an inverse kinematics model is established based on the given end position {xₛ,yₛ,zₛ}. The modeling steps are as follows: first, through geometric calculation, the given end position {xₛ,yₛ,zₛ} is converted into arc parameters {ρ,φ,θ}. That is, according to the geometric calculation of formula (7), given the position of the end point, the arc parameters {ρ,φ,θ} can be obtained as shown below:

$$\{ \begin{matrix}ϕ = {tan}^{- 1} ( \frac{{y}_{s}}{{x}_{s}} ) \\ ρ = \frac{1}{r} = \frac{2 \sqrt{{x}_{s}^{2} + {y}_{s}^{2}}}{{x}_{s}^{2} + {y}_{s}^{2} + {z}_{s}^{2}} \\ θ = {cos}^{- 1} ( 1 - ρ \sqrt{{x}_{s}^{2} + {y}_{s}^{2}} )\end{matrix} ; \qquad ( 8 )$$

Second, converting the arc parameters {ρ,φ,θ} into cavity lengths {l₁,l₂,l₃} Concurrently, it is considered that simultaneous actuation of all three cavities of the soft arm would lead to l₁=l₂=l₃, indicating that the soft arm undergoes extension or contraction motion, potentially causing singularity issues. To avoid potential singularities, a constraint is given: at most two cavities are actuated simultaneously, and at least one cavity maintains its initial length. Therefore, based on geometric calculations, the initial length of cavity {l₁,l₂,l₃} can be calculated from the arc parameters as follows:

$${l}_{i} = r θ - θ h cos [ \frac{2 π}{3} ( i - 1 ) + \frac{π}{2} - ϕ ] , i = 1 , 2 , 3. \qquad ( 9 )$$

Step 3: based on the inverse kinematics model of the soft arm with single-section, a static pressure-length hysteresis model is used as the hysteresis model describing the hysteresis characteristics of the soft arm for hysteresis characteristic prediction. According to the hysteresis model, a reinforcement learning-based control algorithm is set to achieve soft arm end tracking under the influence of gravity and hysteresis.

Specifically, based on the inverse kinematics of the soft arm in formula (8) and formula (9), given the end position {xₛ,yₛ,zₛ}, the corresponding cavity lengths {l₁,l₂,l₃} can be calculated. To convert the cavity lengths {l₁,l₂,l₃} into cavity pressures {u₁,u₂,u₃} while considering the effects of gravity, hysteresis, and nonlinearity, first the hysteresis model of the soft arm is established, and then a control method to compensate for the effects of gravity and external disturbances is designed.

Due to the elasticity of the material, the actuator cavities exhibit asymmetric hysteresis characteristics. Therefore, a static pressure-length hysteresis model is adopted to describe this hysteresis phenomenon, expressed as follows:

$$\{ \begin{matrix}{u}_{p}^{( k )} = {Γ}_{CPI} ( {l}^{( k )} ) + {Γ}_{UPI} ( {l}^{( k )} ) + W ( {l}^{( k )} ) \\ {Γ}_{CPI} ( {l}^{( k )} ) = {a}_{0} {l}^{( k )} + {\sum }_{j = 1}^{{N}_{c}} {b}_{j} {G}_{{γ}_{j} , {c}_{j} , 1} ( {l}^{( k )} ) \\ {Γ}_{UPI} ( {l}^{( k )} ) = {\sum }_{j = 1}^{{N}_{u}} {δ}_{j} {G}_{{γ}_{j} , {c}_{j} , {d}_{j}} ( {l}^{( k )} ) \\ W ( {l}^{( k )} ) = {\sum }_{j = 2}^{{N}_{w}} {{w}_{j} ( {l}^{( k )} )}^{j} + {w}_{0} \\ {G}_{{γ}_{j} , {c}_{j} , {d}_{j}} ( {l}^{( k )} ) = max \{ {c}_{j} ( {l}^{( k )} - {γ}_{j} ) , min \{ {d}_{j} ( {l}^{( k )} + {γ}_{j} ) , {G}_{{γ}_{j} , {c}_{j} , {d}_{j}} ( {l}^{( k - 1 )} ) \} \}\end{matrix} ; \qquad ( 10 )$$

where, l^{(k)} represents the cavity length;

$${u}_{p}^{( k )}$$

denotes the actual pressure in the hysteresis model, which is composed of a symmetric part Γ_{CPI}(l^{(k)}), an asymmetric part Γ_{UPI}(l^{(k)}), and a polynomial part W(l^{(k)}) to fit the formal curve; G_{γ}_{ⱼ}_{,c}_{ⱼ}_{,d}_{ⱼ} (l^{(k)}) is the operator output of the hysteresis model; a₀ is the linear weight gain amplifying l^{(k)}, while bᵢ, δᵢⱼ and wᵢ are respective weight gains; γᵢ corresponds to the j-th dead zone, defined as the input signal range yielding zero output; cⱼ and dⱼ represent the j-th tilt angles during pressurization and depressurization processes, respectively; w₀ is the offset associated with the operational angle of the hysteresis curve; N_{c} and N_{w} indicate the counts of symmetric and polynomial components, respectively; Nᵤ is the total number of dead zones in the asymmetric part; with the superscript (k) denoting the k-th value and the superscript (k−1) referring to the (k−1)-th value.

The cavity pressure

$${u}_{p}^{( k )}$$

predicted oy me model in formula (10) is treated as a feedforward term. However, the prediction performance is susceptible to external disturbances. To address this issue, a proportional-integral-derivative (PID) control compensation term

$${u}_{c}^{( k )}$$

is introduced as a feedback term to modify the actual cavity pressure

$${u}_{a}^{( k )} ,$$

expressed as follows:

$${u}_{a}^{( k )} = {u}_{p}^{( k )} + {u}_{c}^{( k )} ; \qquad ( 11 )$$

$${u}_{c}^{( k )} = {k}_{p} {\tilde{l}}^{( k )} + {k}_{i} \int {\tilde{l}}^{( k )} dt + {k}_{d} {\text{?}}^{( k )} ; \qquad ( 12 )$$

where \tilde{l}^{(k)} represents the cavity length error,

$${\tilde{l}}^{( k )} = {l}_{d}^{( k )} - {l}^{( k )} ,$$

the desired cavity length

$${l}_{d}^{( k )}$$

and the actual cavity length l^{(k)} can be calculated from the desired position

$${p}_{S 0 , d}^{S 1}$$

and the actual position

$${p}_{S 0}^{S 1}$$

according to formula (8) and formula (9), respectively; kₚ, kᵢ and k_{d} are the proportional, integral, and derivative coefficients, respectively. To enhance the feedback control performance, the proportional coefficient kₚ is adjusted and set as an exponential function, expressed as follows:

$${k}_{p} = {k}_{p 0} + {λ}_{1} {e}^{( {λ}_{2} - \frac{{λ}_{3}}{\vert {\tilde{l}}^{( k )} \vert} )} ; \qquad ( 13 )$$

where kₚ₀, λ₁, λ₂ and λ₃ are positive constants, representing the constant term and the terms determining the exponential value, respectively; and to smoothly adjust the coefficient kₚ, the Sarsa learning algorithm is employed to determine this parameter online. To evaluate the performance of the end-effector, the state space [symbol] is defined and partitioned into several consecutive and symmetric intervals S₁-S₇, as follows:

$$S = \{ {S}_{1} , {S}_{2} , {S}_{3} , {S}_{4} , {S}_{5} , {S}_{6} , {S}_{7} \} \qquad ( 14 )$$

$$\{ \begin{matrix}{S}_{1} : \tilde{l} ∈ ( - ∞ , - 50 ) ; & {S}_{2} : \tilde{l} ∈ [ - 50 , - 1 ) ; \\ {S}_{3} : \tilde{l} ∈ [ - 1 , - 0.0001 ) ; & {S}_{4} : \tilde{l} ∈ [ - 0.0001 , 0.0001 ] \\ {S}_{5} : \tilde{l} ∈ ( 0.0001 , 1 ] , & {S}_{6} : \tilde{l} ∈ ( 1 , 50 ] \\ {S}_{7} : \tilde{l} ∈ ( 50 , + ∞ ) & \end{matrix} .$$

Then, an action space [symbol] comprising four actions A₁-A₄ is defined, which adjust the parameters kₚ₀, λ₁, λ₂ and λ₃ respectively, expressed as follows:

$$𝔸 = \{ {A}_{1} , {A}_{2} , {A}_{3} , {A}_{4} \} , \qquad ( 15 )$$

$${A}_{i} : [ {k}_{p 0} , {λ}_{1} , {λ}_{2} , {λ}_{3} \} , i = 1 , … , 4.$$

This indicates that in the current state \tilde{l}^{(k)}, an action A^{(k)} can be selected from the action space [symbol] , and the proportional coefficient kₚ can be determined using formula (15). Furthermore, to evaluate the selected action, a reward table R( [symbol] , [symbol] )∈ [symbol] ^{7×4} is designed based on the state space [symbol] and the action space [symbol] . Next, to enable the soft arm to learn to select the optimal action, an improved ϵ-greedy strategy is adopted to reduce the diversity of action selection and improve the convergence speed. The improved ϵ-greedy strategy is defined as follows:

$$\{ \begin{matrix}if rand ( ) < ϵ , {A}^{( k )} ← {rand}_{A} ( 𝔸 \{ {A}_{1} , {A}_{2} , {A}_{3} , {A}_{4} \} ) \\ else if {\tilde{l}}^{( k )} ∈ {S}_{1} , {A}^{( k )} ← {max}_{A} ( V ( {S}_{1} , \{ {A}_{1} \} ) \\ else if {\tilde{l}}^{( k )} ∈ {S}_{2} , {A}^{( k )} ← {max}_{A} V ( {S}_{2} , \{ {A}_{1} , {A}_{2} \} ) \\ else if {\tilde{l}}^{( k )} ∈ {S}_{3} , {A}^{( k )} ← {max}_{A} V ( {S}_{3} , \{ {A}_{2} , {A}_{3} \} ) \\ else if {\tilde{l}}^{( k )} ∈ {S}_{4} , {A}^{( k )} ← {max}_{A} V ( {S}_{4} , \{ {A}_{3} , {A}_{4} \} ) \\ else if {\tilde{l}}^{( k )} ∈ {S}_{5} , {A}^{( k )} ← {max}_{A} V ( {S}_{5} , \{ {A}_{2} , {A}_{3} \} ) \\ else if {\tilde{l}}^{( k )} ∈ {S}_{6} , {A}^{( k )} ← {max}_{A} V ( {S}_{6} , \{ {A}_{1} , {A}_{2} \} ) \\ else if {\tilde{l}}^{( k )} ∈ {S}_{7} , {A}^{( k )} ← {max}_{A} V ( {S}_{7} , \{ {A}_{1} \} )\end{matrix} ; \qquad ( 16 )$$

where, the parameter ϵ∈(0, 1), V( [symbol] , [symbol] )∈ [symbol] ^{7×4} is the state-action value, which is expressed as follows:

$$V ( {S}_{i}^{( k )} , {A}_{i}^{( k )} ) ← V ( {S}_{i}^{( k )} , {A}_{i}^{( k )} ) + β [ R ( {S}_{i}^{( k + 1 )} , {A}_{i}^{( k + 1 )} ) + σ V ( {S}_{i}^{( k + 1 )} , {A}_{i}^{( k + 1 )} ) - V ( {S}_{i}^{( k )} , {A}_{i}^{( k )} ) ] ; \qquad ( 17 )$$

where, β is the learning rate and σ is the discount factor; following formulas (11) to (17), adaptive inverse kinematics control of the soft arm based on reinforcement learning can be realized.
Step 4: establishing a dynamic model of the fully actuated UAV platform with six-degree-of-freedom inputs. Then, based on model predictive control while considering nonlinear system dynamics and external disturbances, implementing nonlinear model predictive control using an extended Kalman filter estimator to impose constraints on states and inputs. This enables the enforcement of lateral force constraints for the fully actuated UAV platform with tilted rotors, ensuring accurate tracking of the platform under additional disturbances and completing the entire control process.

Specifically, first, using the Newton-Euler method to model the dynamics of the fully actuated UAV platform as follows:

$$[ \begin{matrix}{m}_{s} {\dot{v}}_{b} \\ {J}_{b} {\dot{ω}}_{b}\end{matrix} ] + [ \begin{matrix}{{m}_{s} [ 00 g ]}^{T} \\ {ω}_{b} \times {J}_{b} {ω}_{b}\end{matrix} ] = [ \begin{matrix}{F}_{c} \\ {τ}_{c}\end{matrix} ] + [ \begin{matrix}{F}_{e} \\ {τ}_{e}\end{matrix} ] ; \qquad ( 18 )$$

where, mₛ represents the total mass of the fully actuated UAV platform, J_{b} denotes its inertia matrix, and g is the gravitational constant; the vector \dot{v}_{b} is the first-order derivative of the vector v_{b}, where v_{b} is the linear velocity of the fully actuated UAV platform in the world coordinate system; ω_{b} is the angular velocity of the platform in the body coordinate system, and the vector \dot{ω}_{b} is the first-order derivative of ω_{b}; F_{c} and τ_{c} are the control input force and moment force of the fully actuated UAV platform, respectively; while Fₑ and τₑ are the disturbance force and moment force acting on the platform, respectively.

Subsequently, the position and attitude dynamics of the fully actuated UAV platform are expressed as follows:

$${\dot{p}}_{b} = {v}_{b} ; \qquad ( 19 )$$

$${\dot{q}}_{b} = \frac{1}{2} {q}_{b} ⊗ [ \begin{matrix}0 \\ {ω}_{b}\end{matrix} ] ; \qquad ( 20 )$$

where, the vector \dot{p}_{b} is the first derivative of the vector p_{b}, where p_{b} represents the position of the fully actuated UAV platform in the world coordinate system; the vector \dot{q}_{b} is the first derivative of the vector q_{b}, where q_{b} denotes the attitude of the fully actuated UAV platform represented by a quaternion.

For a tilted-rotor configuration with fixed angles, lateral forces are typically constrained. Therefore, actuator saturation in the lateral direction must be considered. Consequently, model predictive control technology is introduced to enforce state and input constraints, ensuring stable flight tracking of the fully actuated UAV platform. The state vector X and input vector u are defined as follows:

$$x = {[ {p}_{b}^{T} , {v}_{b}^{T} , {q}_{b}^{T} , {ω}_{b}^{T} ]}^{T} ; \qquad ( 21 )$$

$$u = {[ {F}_{c}^{T} , {τ}_{c}^{T} ]}^{T} ; \qquad ( 22 )$$

The system dynamics \dot{x}=ƒ(x) can be described by formulas (18) to (20), and the nonlinear optimal control problem is defined as follows:

$${min}_{{U}_{i}} {\sum }_{k = 0}^{N - 1} ( {x}_{k}^{T} {Q}_{x} {x}_{k} + {u}_{k}^{T} {R}_{u} {u}_{k} ) + {x}_{N}^{T} {Q}_{N} {x}_{N} ; \qquad ( 23 )$$

$$subject to :$$

$${x}_{0} = x , \dot{x} = f ( x ) ,$$

$${x}_{k} ∈ 𝕏 , {u}_{k} ∈ 𝕌 ,$$

$${F}_{e} = {\hat{F}}_{e} , {τ}_{e} = {\hat{τ}}_{e} ,$$

where, \tilde{x}ₖ=xₖ−x_{k,d}, ũₖ=uₖ−u_{k,d}, with x_{k,d} and u_{k,d} being the desired state vector and desired input vector, respectively; Qₓ≥0 and Rᵤ≥0 represent the state and input penalty matrices, respectively, and Q_{N} denotes the terminal state penalty matrix; N represents the prediction step size; [symbol] and [symbol] the state and input constraints, respectively; \hat{F}ₑ and \hat{τ}ₑ are the estimated disturbance force and the estimated moment, respectively.

To estimate unmodeled system dynamics and external disturbances, an extended Kalman filter-based disturbance observer is incorporated into the nonlinear model predictive controller design to achieve offset-free tracking control behavior. Integrating the dynamic model equations from formulas (18) to (20) within the nonlinear model predictive controller, the state vector \hat{x}_{EKF} and input vector u_{ERF} for the extended Kalman filter method are defined as follows:

$${\hat{x}}_{EKF} = {[ {\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T} ]}^{T} ; \qquad ( 24 )$$

$${u}_{EKF} = {[ {F}_{c}^{T} , {τ}_{c}^{T} ]}^{T} ; \qquad ( 25 )$$

where,

$${\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T}$$

respectively represent the estimated values of the extended Kalman filter-based variables

$${p}_{b}^{T} , {v}_{b}^{T} , {q}_{b}^{T} , {ω}_{b}^{T} , {F}_{e}^{T} , {τ}_{e}^{T}$$

subsequently, the measured position, attitude, linear velocity, and angular velocity of the fully actuated UAV platform are used as the measurement vector ZEKE for the extended Kalman filter, as follows:

$${z}_{EKF} = {[ {p}_{b}^{T} , {v}_{b}^{T} , {q}_{b}^{T} , {ω}_{b}^{T} ]}^{T} ; \qquad ( 26 )$$

Subsequently, the multiple shooting technique and the ACADO toolkit are employed to solve the optimal control problem in formula (23); the system dynamics and constraints are discretized on discrete-time sequences of the sampling intervals t₀, . . . , t_{N}, where a 4^{th}-order implicit Runge-Kutta integrator is used to forward-simulate the system dynamics along the intervals. Then, a boundary value problem is solved for each sampling interval.

By utilizing the motion control method of the fully actuated UAV platform, namely formula (23), and the inverse kinematics control algorithm of the soft arm, namely formula (11), the flexible aerial manipulation of the rigid-soft integrated aerial contact-operating robot system in constrained environments is achieved.

The above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A control method of a rigid-flexible integrated aerial contact operation robot, wherein the rigid-flexible integrated aerial contact operation robot comprises a fully-actuated multi-rotor unmanned aerial vehicle (UAV) with tilted rotors, a rotation mechanism, and a working arm; a central portion of the rotation mechanism is fixed to a central fuselage of the multi-rotor unmanned aerial vehicle, and an outer ring portion of the rotation mechanism is rotationally assembled on the central portion, the working arm is connected to the outer ring portion so as to rotate with the outer ring portion around the central fuselage of the multi-rotor unmanned aerial vehicle, and a plane formed by the working arm during its rotation with the rotation mechanism is perpendicular to a plane collectively defined by shafts of all rotors of the multi-rotor unmanned aerial vehicle, furthermore, during its rotation, the working arm remains clear of and does not interfere with the various rotors and their shafts;
the working arm comprises a proximal rigid arm connected to the rotation mechanism, a distal rigid arm equipped with an end-effector at its tip, and a soft arm connected between the proximal rigid arm and the distal rigid arm, and the soft arm is a bending soft with a single-section structure;
comprising following steps:
step 1: constructing a coordinate system group comprising a world coordinate system, a multi-rotor UAV body coordinate system, a rotation mechanism coordinate system, a soft arm base coordinate system, a soft arm end coordinate system, and an end-effector coordinate system, and based on this coordinate system group, establishing a forward kinematics model that describes transformational relationships between motion of the end-effector and motions of other moving parts;
step 2: based on end position of the soft arm, converting it into arc parameters via geometric calculation, and then further converting these into cavity lengths of each bending soft, thereby establishing an inverse kinematics model for the soft arm;
step 3: based on the inverse kinematics model of the soft arm with single-section, using a static pressure-length hysteresis model as the hysteresis model describing hysteretic characteristics of the soft arm to predict the hysteretic characteristics, then based on the hysteresis model, formulating a reinforcement learning-based control algorithm to achieve end-point tracking for the soft arm;
step 4: establishing a dynamic model of a fully-actuated UAV platform with six-degree-of-freedom inputs, subsequently, based on model predictive control (MPC), considering nonlinear system dynamics and external disturbances to implement nonlinear model predictive control (NMPC) using an extended Kalman filter (EKF) estimator to constrain states and inputs, thereby achieving lateral force constraints for the fully-actuated UAV platform with tilted rotors and completing an entire control process.

2. The method according to claim 1, wherein in the step 1, the forward kinematics model is expressed as:
$${T}_{E}^{I} = {T}_{B}^{I} {T}_{M}^{B} {T}_{E}^{M} = [ \begin{matrix}{R}_{E}^{I} & {p}_{e} \\ 0 & 1\end{matrix} ] ;$$
$$where {R}_{E}^{I} = {R}_{B}^{I} {R}_{M}^{B} {R}_{E}^{M} , {p}_{e} = {p}_{b} + {R}_{B}^{I} ( {p}_{m}^{b} + {R}_{M}^{B} {p}_{e}^{m} ) ;$$
$${T}_{*}^{★} ∈ {ℝ}^{4 \times 4} and {R}_{*}^{⋆} ∈ {ℝ}^{3 \times 3}$$
represent a transformation matrix and rotation matrix from a coordinate system “*” to a coordinate system “*” respectively, and symbol *={B,M,E} and symbol *={I,B,M}, [symbol] denotes a set of real numbers, B represents a body coordinate system [symbol] _{B} of a UAV platform, M represents the rotation mechanism coordinate system [symbol] _{M}, E represents the end-effector coordinate system [symbol] _{E}, and I represents the world coordinate system [symbol] _{I}; pₑ=[xₑ,yₑ,zₑ]^{T}∈ [symbol] ³ is a position of the end-effector in the world coordinate system [symbol] _{I},
$${p}_{m}^{b} ∈ {ℝ}^{3}$$
is a joint position of the rotation mechanism in the body coordinate system [symbol] _{B},
$${p}_{e}^{m} ∈ {ℝ}^{3}$$
is a position of the end-effector in the rotation mechanism coordinate system [symbol] _{M}, a superscript T denotes matrix transpose, and p_{b} is a position of the UAV platform in the world coordinate system [symbol] _{I}.

3. The method according to claim 2, wherein the transformation matrix is
$${T}_{E}^{M} = {T}_{S 0}^{M} {T}_{S 1}^{S 0} {T}_{E}^{S 1} , where {T}_{S 0}^{M}$$
is the transformation matrix between the rotation mechanism coordinate system [symbol] _{M} and the soft arm base coordinate system [symbol] _{S0},
$${T}_{S 1}^{S 0}$$
represents the transformation matrix between the soft arm base coordinate system [symbol] _{S0} and a soft manipulator end coordinate system [symbol] _{S1}, and
$${T}_{E}^{S 1}$$
is the transformation matrix between the end-effector coordinate system [symbol] _{E} and the soft manipulator end coordinate system [symbol] _{S1}, furthermore:
$$\begin{matrix}{T}_{S 0}^{S 1} = [ \begin{matrix}{R}_{z} ( ϕ ) & 0 \\ 0 & 1\end{matrix} ] [ \begin{matrix}{R}_{y} ( θ ) & {p}_{θ} \\ 0 & 1\end{matrix} ] [ \begin{matrix}{R}_{z} ( - ϕ ) & 0 \\ 0 & 1\end{matrix} ] \\ = [ \begin{matrix}{R}_{S 0}^{S 1} & {p}_{S 0}^{S 1} \\ 0 & 1\end{matrix} ]\end{matrix} ;$$
$$where , {R}_{S 0}^{S 1} = [ \begin{matrix}{c}_{ϕ}^{2} ( {c}_{θ} - 1 ) + 1 & {s}_{ϕ} {c}_{ϕ} ( {c}_{θ} - 1 ) & {c}_{ϕ} {s}_{θ} \\ {s}_{ϕ} {c}_{ϕ} ( {c}_{θ} - 1 ) & {s}_{ϕ}^{2} ( {c}_{θ} - 1 ) + 1 & {s}_{ϕ} {s}_{θ} \\ - {c}_{ϕ} {s}_{θ} & - {c}_{ϕ} {s}_{θ} & {c}_{θ}\end{matrix} ] ,$$
$${p}_{S 0}^{S 1} = {[ {x}_{e} , {y}_{e} , {z}_{e} ]}^{T} \text{?} {γ [ {c}_{ϕ} ( 1 - {c}_{θ} ) , {s}_{ϕ} ( 1 - {c}_{θ} ) , {s}_{θ} ]}^{T} ,$$
c_{φ}, s_{φ}, c_{θ} and s_{θ} represent cos φ, sin φ, cos θ and sin θ respectively, where φ is a curvature angle of the soft arm, and θ is a bending angle of the soft arm;
$${p}_{S 0}^{S 1} and {R}_{S 0}^{S 1}$$
represent a translational motion and a rotational motion in the soft arm base coordinate system [symbol] _{S0} respectively, R_{y}(θ) represents a rotation angle of the soft arm around y-axis of the soft arm base coordinate system [symbol] _{S0}, R_{z}(φ) represents a rotation angle φ around z-axis of the soft arm base coordinate system [symbol] _{S0}, xₛ, yₛ, zₛ are the x-axis, y-axis, and z-axis coordinates of a task space of the soft arm, i.e., a desired end-position to be reached.

4. The method according to claim 3, wherein the step 2 comprises:
step 201: converting the end position {xₛ,yₛ,zₛ} into the arc parameters {ρ,φ,θ} by following calculation formula:
$$\{ \begin{matrix}ϕ = {tan}^{- 1} ( \frac{{y}_{s}}{{x}_{s}} ) \\ ρ = \frac{1}{r} = \frac{2 \sqrt{{x}_{s}^{2} + {y}_{s}^{2}}}{{x}_{s}^{2} + {y}_{s}^{2} + {z}_{s}^{2}} \\ θ = {cos}^{- 1} ( 1 - ρ \sqrt{{x}_{s}^{2} + {y}_{s}^{2}} )\end{matrix} ;$$
wherein r is a radius of curvature, and ρ is the curvature of the soft arm;
step 202, calculating the cavity length of each bending soft by following calculation formula:
$$ρ = \frac{1}{r} = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{h ( {l}_{1} + {l}_{2} + {l}_{3} )} ;$$
$$ϕ = {tan}^{- 1} ( \frac{\sqrt{3} ( {l}_{2} + {l}_{3} - 2 {l}_{1} )}{3 ( {l}_{2} - {l}_{3} )} ) ;$$
$$θ = \frac{2 \sqrt{{l}_{1}^{2} + {l}_{2}^{2} + {l}_{3}^{2} - {l}_{1} {l}_{2} - {l}_{1} {l}_{3} - {l}_{2} {l}_{3}}}{3 h} ;$$
constraint conditions are:
$${l}_{i} = r θ - θ h cos [ \frac{2 π}{3} ( i - 1 ) + \frac{π}{2} - ϕ ] , i = 1 , 2 , 3 ;$$
where, lᵢ represents the cavity length of i-th bending soft, h represents a radius of a cross-section, and π represents a circular constant.

5. The method according to claim 4, wherein in the step 3, the hysteresis model is expressed by following formula:
$$\{ \begin{matrix}{u}_{p}^{( k )} = {Γ}_{CPI} ( {l}^{( k )} ) + {Γ}_{UPI} ( {l}^{( k )} ) + W ( {l}^{( k )} ) \\ {Γ}_{CPI} ( {l}^{( k )} ) = {a}_{0} {l}^{( k )} + {\sum }_{j = 1}^{N} {b}_{j} {G}_{{γ}_{j} , {c}_{j} , 1} ( {l}^{( k )} ) \\ {Γ}_{UPI} ( {l}^{( k )} ) = {\sum }_{j = 1}^{{N}_{u}} {δ}_{j} {G}_{{γ}_{j} , {c}_{j} , {d}_{j}} ( {l}^{( k )} ) \\ W ( {l}^{( k )} ) = {\sum }_{j = 2}^{{N}_{w}} {{w}_{j} ( {l}^{( k )} )}^{j} + {w}_{0} \\ {G}_{{γ}_{j} , {c}_{j} , {d}_{j}} ( {l}^{( k )} ) = max \{ {c}_{j} ( {l}^{( k )} - {γ}_{j} ) , min \{ {d}_{j} ( {l}^{( k )} + {γ}_{j} ) , {G}_{{γ}_{j} , {c}_{j} , {d}_{j}} ( {l}^{( k - 1 )} ) \} \}\end{matrix} ;$$
where l^{(k)} is the cavity length,
$${u}_{p}^{( k )}$$
is pressure inside a cavity in the hysteresis model, the pressure is expressed through a symmetric part Γ_{CPI}(l^{(k)}), an asymmetric part Γ_{UPI}(l^{(k)}) and a polynomial part W(l^{(k)}) to fit a formal curve; G_{γ}_{ⱼ}_{,c}_{ⱼ}_{d}_{ⱼ}(l^{(k)}) is an operator output of the hysteresis model, a superscript (k) denotes k-th value, a superscript (k−1) denotes (k−1)-th value; a₀ is a linear weight gain, while bᵢ, δᵢⱼ and wᵢ are weight gains of the symmetric, asymmetric, and polynomial parts, respectively; γⱼ is j-th dead zone which corresponds to an input signal range where an output is zero; cⱼ and dⱼ are j-th inclination angles of the cavity during pressurization and depressurization, respectively; w₀ is an offset associated with an operating angle of the hysteresis curve; N_{c} and N_{w} are numbers of symmetric and polynomial parts, respectively; Nᵤ is a total number of dead zones in the asymmetric part;
then, a proportional-integral-derivative control compensation term
$${u}_{c}^{( k )}$$
is introduced as a feedback term to modify a feedforward term
$${u}_{p}^{( k )}$$
in the hysteresis model in real time, given by:
$${u}_{a}^{( k )} = {u}_{p}^{( k )} + {u}_{c}^{( k )} ;$$
$${u}_{c}^{( k )} = {k}_{p} {\tilde{l}}^{( k )} + {k}_{i} \int {\tilde{l}}^{( k )} d t + {k}_{d} {\text{?}}^{( k )} ;$$
where \tilde{l}^{(k)} denotes a cavity length error,
$${\tilde{l}}^{( k )} = {l}_{d}^{( k )} - {l}^{( k )} , {l}_{d}^{( k )}$$
is a desired cavity length, l^{(k)} is an actual cavity length, and
$${\tilde{l}}^{( k )} , {l}_{d}^{( k )} and {l}^{( k )}$$
are calculated from a desired position or an actual position of the end-point of the soft arm using formula in the step 201 to calculate the arc parameters {ρ,φ,θ}, and then using the constraint conditions for calculating the cavity length of each bending soft in the step 202; kₚ, kᵢ and k_{d} are proportional, integral, and derivative coefficients, respectively; wherein the proportional coefficient kₚ is configured as an exponential function expressed as
$${k}_{p} = {k}_{p 0} + {λ}_{1} {e}^{( {λ}_{2} - \frac{{λ}_{3}}{\vert {\tilde{l}}^{( k )} \vert} )} ;$$
where kₚ₀ is a constant term, and λ₁, λ₂ and λ₃ are terms determining an exponent value, all being positive constants, and are determined online via the reinforcement learning-based control algorithm.

6. The method according to claim 5, wherein in the step 3, setting the reinforcement learning-based control algorithm according to the hysteresis model comprises:
employing an epsilon (ϵ)-greedy policy to enable the soft arm to select optimal actions through learning, wherein the ϵ-greedy policy is defined as:
$$\{ \begin{matrix}if rand ( ) < ϵ , {A}^{( k )} ← {rand}_{A} ( 𝔸 \{ {A}_{1} , {A}_{2} , {A}_{3} , {A}_{4} \} ) \\ else if {\tilde{l}}^{( k )} ∈ {S}_{1} , {A}^{( k )} ← {max}_{A} V ( {S}_{1} , \{ {A}_{1} \} ) \\ else if {\tilde{l}}^{( k )} ∈ {S}_{2} , {A}^{( k )} ← {max}_{A} V ( {S}_{2} , \{ {A}_{1} , {A}_{2} \} ) \\ else if {\tilde{l}}^{( k )} ∈ {S}_{3} , {A}^{( k )} ← {max}_{A} V ( {S}_{3} , \{ {A}_{2} , {A}_{3} \} ) \\ else if {\tilde{l}}^{( k )} ∈ {S}_{4} , {A}^{( k )} ← {max}_{A} V ( {S}_{4} , \{ {A}_{3} , {A}_{4} \} ) \\ else if {\tilde{l}}^{( k )} ∈ {S}_{5} , {A}^{( k )} ← {max}_{A} V ( {S}_{5} , \{ {A}_{2} , {A}_{3} \} ) \\ else if {\tilde{l}}^{( k )} ∈ {S}_{6} , {A}^{( k )} ← {max}_{A} V ( {S}_{6} , \{ {A}_{1} , {A}_{2} \} ) \\ else if {\tilde{l}}^{( k )} ∈ {S}_{7} , {A}^{( k )} ← {max}_{A} V ( {S}_{7} , \{ {A}_{1} \} )\end{matrix} ;$$
where rand( ) represents an initial random assignment for decision-making, parameter ϵ∈(0, 1), V( [symbol] , [symbol] )∈ [symbol] ^{7×4} is a state-action value function, expressed as:
$$V ( {S}_{i}^{( k )} , {A}_{i}^{( k )} ) ← V ( {S}_{i}^{( k )} , {A}_{i}^{( k )} ) + β [ R ( {S}_{i}^{( k + 1 )} , {A}_{i}^{( k + 1 )} ) + σ V ( {S}_{i}^{( k + 1 )} , {A}_{i}^{( k + 1 )} ) - V ( {S}_{i}^{( k )} , {A}_{i}^{( k )} ) ] ;$$
where β is a learning rate, σ is a discount factor; [symbol] is a state space, which comprises seven continuous and symmetric intervals S₁-S₇:
$$S = \{ {S}_{1} , {S}_{2} , {S}_{3} , {S}_{4} , {S}_{5} , {S}_{6} , {S}_{7} \}$$
$$\{ \begin{matrix}{S}_{1} : \tilde{l} ∈ ( - ∞ , - 50 ) ; & {S}_{2} : \tilde{l} ∈ [ - 50 , - 1 ) ; \\ {S}_{3} : \tilde{l} ∈ [ - 1 , - 0.0001 ) ; & {S}_{4} : \tilde{l} ∈ [ - 0.0001 , 0.0001 ] ; \\ {S}_{5} : \tilde{l} ∈ ( 0.0001 , 1 ] , & {S}_{6} : \tilde{l} ∈ ( 1 , 50 ] \\ {S}_{7} : \tilde{l} ∈ ( 50 , + ∞ ) & \end{matrix}$$ [symbol]
is an action space comprising four actions A₁-A₄, where:
$$𝔸 = \{ {A}_{1} , {A}_{2} , {A}_{3} , {A}_{4} \} ,$$
$${A}_{i} : [ {k}_{p 0} , {λ}_{1} , {λ}_{2} , {λ}_{3} \} , i = 1 , … , 4.$$

7. The method according to claim 2, wherein in the step 4, the dynamic model of the fully-actuated UAV platform with six-degree-of-freedom inputs is expressed as:
$$[ \begin{matrix}{m}_{s} {\dot{v}}_{b} \\ {J}_{b} {\dot{ω}}_{b}\end{matrix} ] + [ \begin{matrix}{{m}_{s} [ 00 g ]}^{T} \\ {ω}_{b} \times {J}_{b} {ω}_{b}\end{matrix} ] = [ \begin{matrix}{F}_{c} \\ {τ}_{c}\end{matrix} ] + [ \begin{matrix}{F}_{e} \\ {τ}_{e}\end{matrix} ] ;$$
where mₛ is a total mass of the fully-actuated UAV platform, J_{b} is an inertia matrix of the fully-actuated UAV platform, and g is a gravitational constant; a vector \dot{v}_{b} is a first derivative of a vector v_{b}, where v_{b} is a linear velocity of the fully-actuated UAV platform in the world coordinate system; ω_{b} is an angular velocity of the fully-actuated UAV platform in the body coordinate system, and a vector \dot{ω}_{b} is a first derivative of ω_{b}; F_{c} and τ_{c} are the control input force and moment of the fully-actuated UAV platform, respectively; Fₑ and τₑ are disturbance force and moment acting on the fully-actuated UAV platform, respectively;
a position and attitude dynamics of the fully-actuated UAV platform are expressed as:
$${\dot{p}}_{b} = {v}_{b} ;$$
$${\dot{q}}_{b} = \frac{1}{2} {q}_{b} ⊗ [ \begin{matrix}0 \\ {ω}_{b}\end{matrix} ] ;$$
where a vector \dot{p}_{b} is a first derivative of the vector p_{b}, with p_{b} being the position of the fully-actuated UAV platform in the world coordinate system; a vector \dot{q}_{b} is a first derivative of a vector q_{b}, with q_{b} being an attitude of the fully-actuated UAV platform represented by a quaternion.

8. The method according to claim 7, wherein in the step 4, implementing lateral force constraints for the fully-actuated UAV platform comprises:
representing a state vector x and an input vector u as:
$$x = {[ {p}_{b}^{T} , {v}_{b}^{T} , {q}_{b}^{T} , {ω}_{b}^{T} ]}^{T} ;$$
$$u = {[ {F}_{c}^{T} , {τ}_{c}^{T} ]}^{T} ;$$
system dynamics are described by the dynamic model of the fully-actuated UAV platform along with expressions for the position and attitude dynamics position and attitude dynamics, and a nonlinear optimal control is formulated as:
$${min}_{{U}_{i}} {\sum }_{k = 0}^{N - 1} ( {x}_{k}^{T} {Q}_{x} {x}_{k} + {u}_{k}^{T} {R}_{u} {u}_{k} ) + {x}_{N}^{T} {Q}_{N} {x}_{N}$$
$$subject to :$$
$${x}_{0} = x , \dot{x} = f ( x ) ,$$
$${x}_{k} ∈ 𝕏 , {u}_{k} ∈ 𝕌 ,$$
$${F}_{e} = {\hat{F}}_{e} , {τ}_{e} = {\hat{τ}}_{e} ,$$
where \tilde{x}ₖ=xₖ−x_{k,d}, ũₖ=uₖ−u_{k,d}, with x_{k,d} and u_{k,d} being a desired state vector and a desired input vector, respectively; Qₓ≥0 and Rᵤ≥0 denote penalty matrices for a state and an input, respectively, and Q_{N} represents a penalty matrix for a terminal state; N indicates a prediction step size; [symbol] and U are state and input constraints, respectively; \hat{F}ₑ and \hat{τ}ₑ are estimated disturbance force and an estimated moment, respectively;
a state vector \hat{x}_{EKF} and an input vector u_{EKF} of the extended Kalman filter estimator are defined as:
$${\hat{x}}_{EKF} = {[ {\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T} ]}^{T} ,$$
$${u}_{EKF} = {[ {F}_{c}^{T} , {τ}_{c}^{T} ]}^{T} ;$$
$$where {\hat{p}}_{b}^{T} , {\hat{v}}_{b}^{T} , {\hat{q}}_{b}^{T} , {\hat{ω}}_{b}^{T} , {\hat{F}}_{e}^{T} , {\hat{τ}}_{e}^{T}$$
represent estimated values of variables
$${p}_{b}^{T} , {v}_{b}^{T} , {q}_{b}^{T} , {ω}_{b}^{T} , {F}_{c}^{T} , {τ}_{c}^{T}$$
based on the extended Kalman filter; measured position, attitude, linear velocity, and angular velocity of the fully-actuated UAV platform are used as a measurement vector z_{EKF} of the extended Kalman filter, i.e.:
$${z}_{EKF} = {[ {p}_{b}^{T} , {v}_{b}^{T} , {q}_{b}^{T} , {ω}_{b}^{T} ]}^{T} ;$$
then, the system dynamics and constraints are discretized on discrete-time sequences t₀, . . . , t_{N} of sampling intervals, where a 4^{th}-order implicit Runge-Kutta integrator is used to forward simulate the system dynamics along the intervals, and then a boundary value is solved for each sampling interval to obtain the estimated disturbance force \hat{F}ₑ and the estimated moment \hat{τ}ₑ, thereby solving expression of the nonlinear optimal control.
